(19) United States
(12) Patent Application Publication
(10) Pub. No.: US 2015/0276110 A1
(43) Pub. Date: Oct. 1, 2015

(54) QUICK CONNECT COUPLING

(71) Applicant: Parker-Hannifin Corporation, Cleveland, OH (US)

(72) Inventors: Harsh Rajnikant Parekh, Houston, TX (US); Brian Cruickshank, Spring, TX (US)

(21) Appl. No.: 14/668,236

(22) Filed: Mar. 25, 2015

Related U.S. Application Data
(60) Provisional application No. 61/970,082, filed on Mar. 25, 2014.

(51) Int. Cl. F16L 37/252; F16L 21/08; F16L 21/035

(52) U.S. Cl. CPC F16L 37/252; F16L 21/035; F16L 21/08

(57) ABSTRACT

Provided is a coupling including female and male couplers configured to be coupled together. The female coupler includes a notch having one end opening to an axial end face of the body of the female coupler at a forward end and an opposite end having a rearwardly facing groove for retaining a locking element of the male coupler. The groove and locking element connection eliminates a threaded connection between the female and male couplers. By eliminating a threaded connection between the female and male couplers, the couplers prevent leakage of fluid and/or separation of the couplers due to vibration during use.

### FIELD OF INVENTION The present invention relates generally to couplings, and more particularly to quick connect/disconnect couplings for use with anhydrous ammonia devices.

### BACKGROUND

Anhydrous ammonia may be applied to soil by farmers as a fertilizer. Farmers often use a nurse tank containing pressurized liquid anhydrous ammonia as a source. The nurse tank may be provided on a cart that is transported by a farm vehicle across a field while the anhydrous ammonia is distributed to the soil via a tool bar connected to the nurse tank. To connect the nurse tank and the tool bar, one or more hoses may be used. The one or more hoses may be coupled to the nurse tank, and more particularly to a withdrawal valve of the nurse tank and/or the tool bar in any suitable manner, such as by couplers configured to be threaded together, such as acme couplers.

### SUMMARY OF INVENTION

The present invention provides a coupling including female and male couplers configured to be coupled together. The female coupler includes a notch having one end opening to an axial end face of the body of the female coupler at a forward end and an opposite end having a rearwardly facing groove for retaining a locking element of the male coupler. The groove and locking element connection eliminates a threaded connection between the female and male couplers. By eliminating a threaded connection between the female and male couplers, the couplers prevent leakage of fluid and/or separation of the couplers due to vibration during use.

According to one aspect of the invention, a coupling is provided taht includes female and male couplers configured to be coupled together, the male coupler including a body having a forward end, a rearward end, an axially extending cavity, and a locking element, and the female coupler including a body having a forward end, a rearward end, an axially extending cavity for receiving the forward end of the male coupler at the forward end, and a notch having one end opening to an axial end face of the body at the forward end and an opposite end having a rearwardly facing groove for retaining the locking element to prevent rotation of the male coupler relative to the body of the female coupler and to prevent separation of the male and female couplers.

The female coupler may include a resilient member disposed in the axially extending cavity, and wherein the resilient member is interposed between respective stop shoulders on the male and female couplers for resiliently holding the locking element in the rearwardly facing groove.

The locking element may be shiftable rearwardly against the biasing force of the resilient member to release the locking element from the rearwardly facing groove.

The resilient member may have an axial length in an uncompressed state that is greater than a spacing between the stop shoulders when the male and female couplers are coupled together.

The notch may include a ramp portion between the ends for facilitating rotation of the female coupler relative to the male coupler against the force of the resilient member.

The resilient member may be configured to compress progressively as the locking element climbs the ramp portion.

The ramp portion may include a rearwardly extending projection at a base of the ramp portion for holding the locking element in an intermediate position to prevent separation of the male coupler from the female coupler due to pressure in the axially extending cavities.

Fluid in the axially extending cavities may be bled through the notch when the locking element is in the intermediate position.

When the female and male couplers are uncoupled, one end of the resilient member is seated on the stop shoulder of the female coupler and another end of the resilient member is seated against a retainer disposed in the axially extending cavity.

The male coupler may include a pair of locking elements and the female coupler includes a pair of notches each having one end opening to the axial end face of the body at the forward end and an opposite end having a rearwardly facing groove for retaining a respective one of the locking elements.

The ends of the notches opening to the axial end face may be diametrically opposed.

The notches may be oppositely oriented.

Each locking element may project radially outwardly from the body of the male coupler.

The locking elements may be circumferentially spaced.

The locking elements may be equally circumferentially spaced.

The male coupler may include a groove in an outer surface of the body near the forward end and a seal disposed in the groove for sealing the male coupler to the female coupler.

The body of the female coupler may include a collar portion and a socket portion rotatable relative to the collar portion.

The collar portion may include a radially inwardly protruding portion defining an opening through which the socket portion extends.

The radially inwardly protruding portion may be captured between a shoulder of the socket and a retainer in an outer wall of the socket.

According to another aspect of the invention, a female coupler is provided that includes a body having a forward end, a rearward end, an axially extending cavity for receiving a male coupler at the forward end, and a notch having one end opening to an axial end face of the body at the forward end and an opposite end having a rearwardly facing groove for retaining a locking element of the male coupler to prevent separation of the male and female couplers, and a resilient member disposed in the axially extending cavity and being interposed between a stop shoulder of the body and a retainer disposed in the axially extending cavity.

The notch may include a ramp portion between the ends for facilitating rotation of the female coupler relative to the male coupler against the force of the resilient member.

The resilient member may be configured to compress progressively as the locking element climbs the ramp portion.

The ramp portion may include a rearwardly extending projection at a base of the ramp portion for holding the locking element in an intermediate position to prevent separation of the male coupler from the female coupler due to pressure in the axially extending cavity.

Fluid in the axially extending cavity is bled through the notch when the locking element is in the intermediate position.

The female coupler may include a pair of notches each having one end opening to the axial end face of the body at the forward end and an opposite end having a rearwardly facing groove for retaining a respective locking element.

The ends of the notches opening to the axial end face may be diametrically opposed.

The notches may be oppositely oriented.

The body may include a collar portion and a socket portion rotatable relative to the collar portion.

The collar portion may include a radially inwardly protruding portion defining an opening through which the socket portion extends.

The radially inwardly protruding portion may be captured between a shoulder of the socket and a retainer in an outer wall of the socket.

According to still another aspect of the invention, a female coupler is provided that has a forward end, a rearward end, an axially extending cavity for receiving a male coupler at the forward end, and a notch having an entry portion into which a locking element of the male coupler is configured to be received, an intermediate ramp portion through which the anti-rotate element is configured to climb, and a lock portion having a rearwardly facing locking groove for retaining the locking element to prevent separation of the male and female couplers and to constrain the male coupler against rotation.

The foregoing and other features of the invention are hereinafter described in greater detail with reference to the accompanying drawings.

### BRIEF DESCRIPTION OF THE DRAWINGS

FIG. 1 is a perspective view of a cart having tanks with valves coupled to hoses via exemplary couplers according to the invention.

FIG. 2 is a perspective view of the exemplary coupler according to the invention having male and female couplers in an engaged position.

FIG. 3 is a perspective view of the exemplary coupler having male and female couplers in a disengaged position.

FIG. 4 is a cross-sectional view of the exemplary coupler taken about line 4-4 in FIG. 3.

FIG. 5 is a cross-sectional view of the exemplary coupler taken about line 5-5 in FIG. 2.

FIG. 6 is a cross-sectional view of the exemplary coupler showing the male coupler partially inserted into the female coupler.

FIG. 7 is a perspective view of another exemplary coupler according to the invention having male and female couplers in an engaged position.

FIG. 8 is another perspective view of the coupler of FIG. 7.

FIG. 9 is a cross-sectional view of the exemplary coupler taken about line 9-9 in FIG. 7.

FIG. 10 is a perspective view of the male coupler.

FIG. 11 is a perspective view of a collar portion of the female coupler.

### DETAILED DESCRIPTION

The principles of the present invention have particular application to quick connect/disconnect couplings for connecting a source of fluid, such as liquid anhydrous ammonia, to a tool bar to distribute the fluid to soil, and thus will be described below chiefly in this context. It will of course be appreciated, and also understood, that the principles of the invention may be useful in other fluid coupling applications where it is desirable to prevent separation of couplings due to pressure.

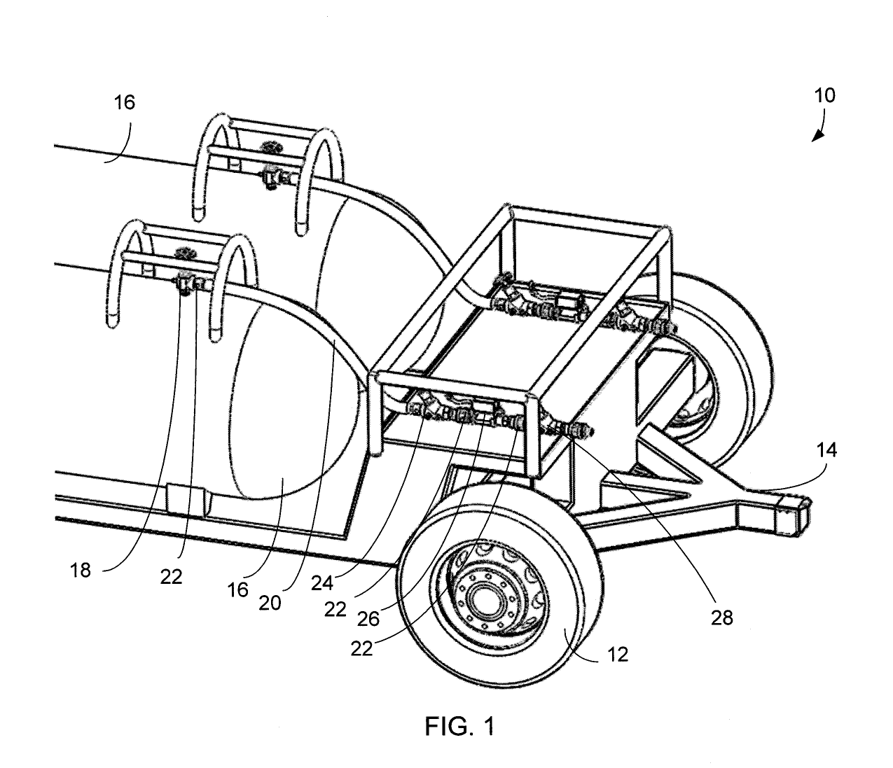

Turning now to FIG. 1, an exemplary anhydrous ammonia cart is illustrated generally at reference numeral 10. The cart 10 may include a plurality of wheels 12, a hitch 14 configured to couple to tool bar that couples to a farm vehicle, and a plurality of nurse tanks 16 containing pressurized liquid anhydrous ammonia. Each tank 16 includes a withdrawal valve 18 through which the liquid exits the tank. The withdrawal valves 18 are coupled to respective hoses 20 using an exemplary quick connect/disconnect coupling 22 that will be described in detail below. The flexible hose 20 may be coupled to another suitable valve 24, which may be coupled to a shut off valve 26 using the coupling 22. The shut off valve 26 may then be coupled to a further suitable valve 28 using the coupling 22. The valve 28 may be coupled to a hose (not shown), for example by the coupling 22, and an end of the hose configured to be coupled to the tool bar may be coupled to one of a male or female coupler of the coupling 22.

The couplings 22 allow the various components to be quickly connected and disconnected without using a threaded connection. By eliminating the threaded connection between male and female couplers of the coupling 22, leakage of fluid and/or separation of the couplers due to vibration during use are prevented. The couplings 22 also allow for the length of a hose to be efficiently changed, thereby reducing or eliminating leakage that results from using an incorrect length of hose.

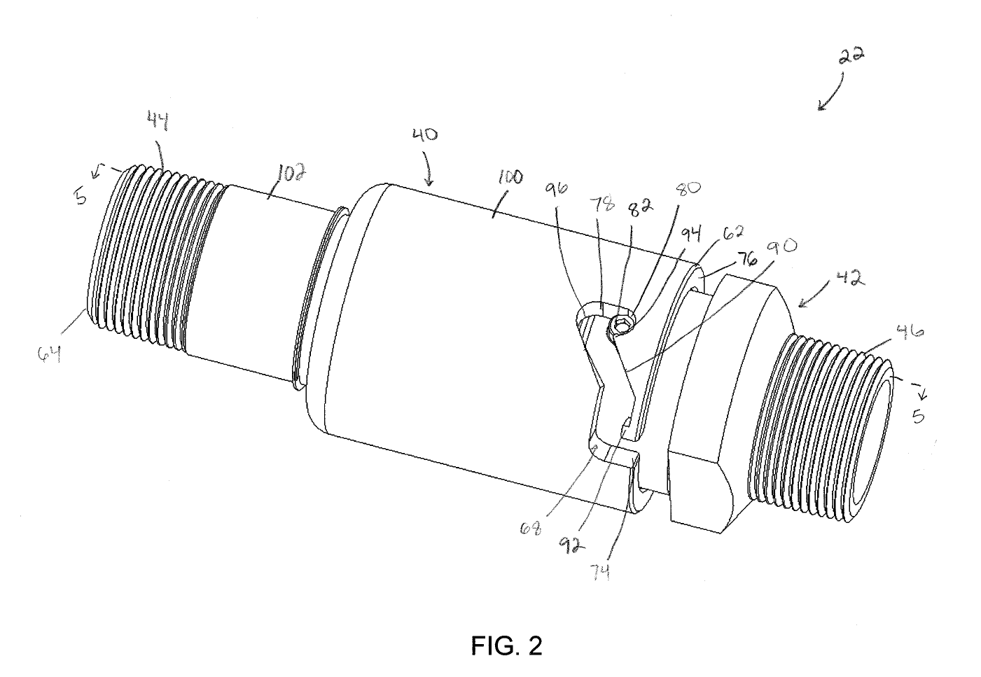

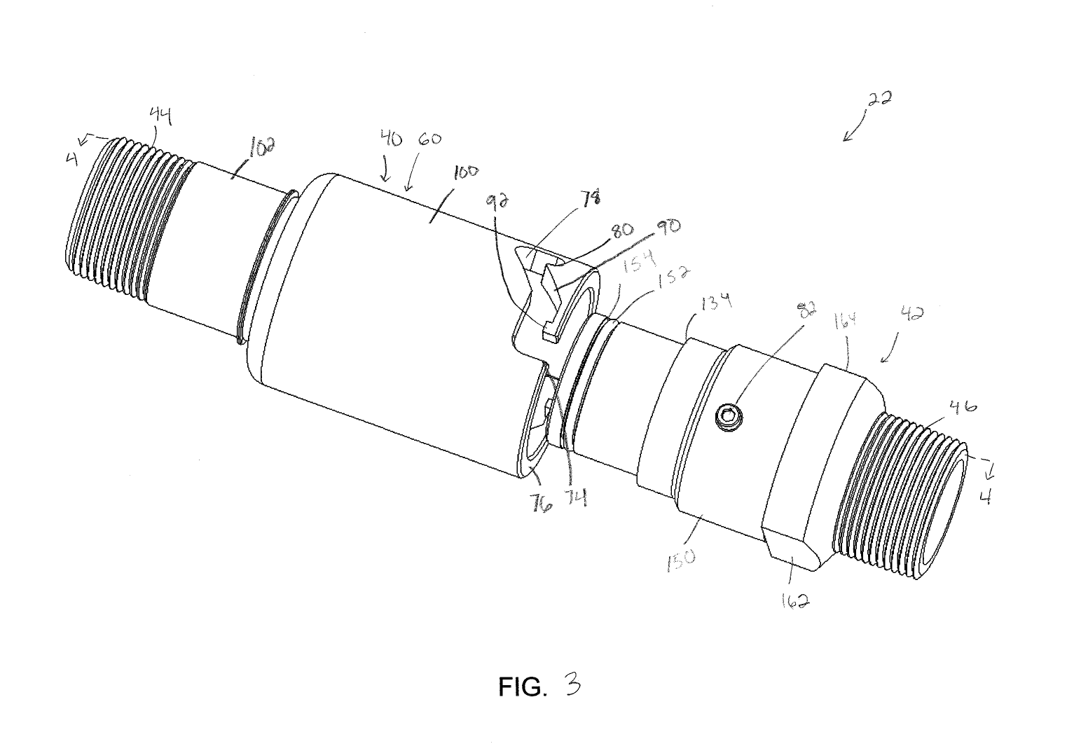

Referring now to FIGS. 2 and 3, the exemplary quick connect/disconnect coupling 22 will be discussed in detail. The coupling 22 includes a female coupler 40 and a male coupler 42 that may be connected to provide liquid from one of the tanks 16 to the hose 20, for example. The female and male couplers 40 and 42 include threaded ends 44 and 46, respectively, which may be coupled, for example, to the withdrawal valve 18 and the flexible hose 20, respectively. It will be appreciated that the ends 44 and 46 may be any suitable ends for either permanently or removably coupling the female and male couplers 40 and 42 to respective components.

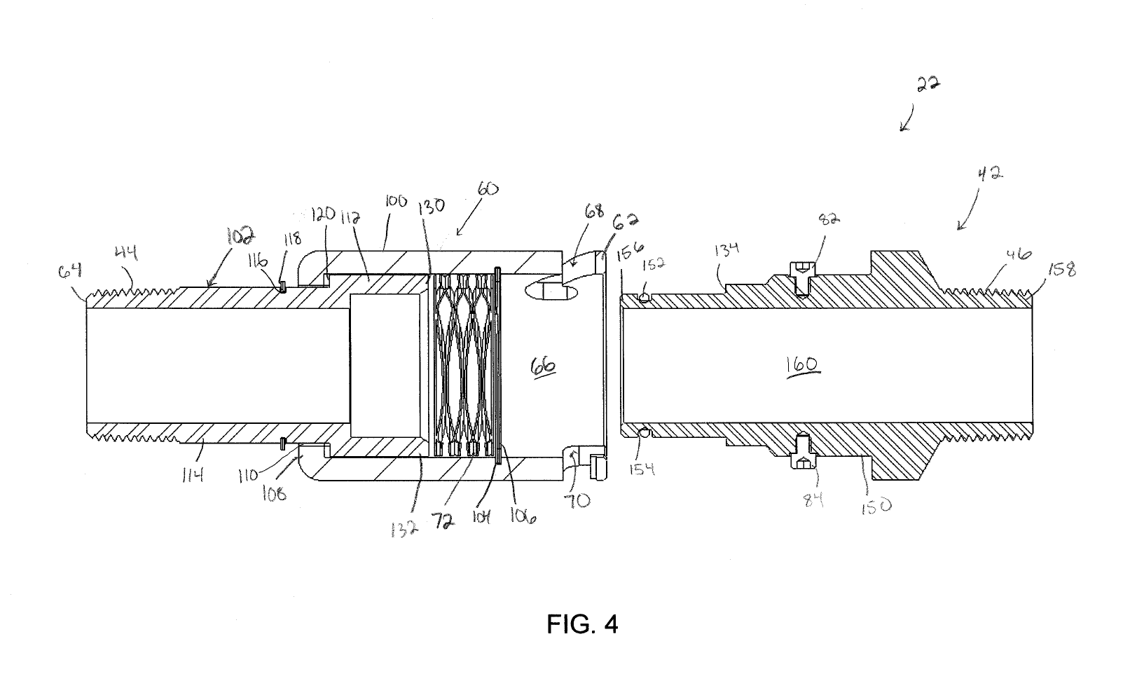

With continued reference to FIGS. 2 and 3 along with FIG. 4, the female coupler 40 includes a body 60 having a forward end 62, a rearward end 64, an axially extending cavity 66 for receiving the male coupler 42 at the forward end 62, and one or more notches, such as first and second notches 68 and 70. The female coupler 40 also includes a resilient member 72 disposed in the axially extending cavity 66. The first and second notches 68 and 70 extend through the body 60 such that the axially extending cavity 66 communicates with the area outside the female coupler 40 when the female coupler 40 is uncoupled from the male coupler 42.

The first and second notches 68 and 70 may be oppositely oriented and each have diametrically opposed ends 74 opening to an axial end face 76 of the body 60 at the forward end 62, and opposite ends 78 having a rearwardly facing groove 80. The rearwardly facing grooves 80 retain a respective locking element 82, 84 of the male coupler 42 to prevent rotation of the male coupler 42 relative to the body 60 and to prevent separation of the female and male couplers 40 and 42.

The first and second notches 68 and 70 each also include a ramp portion 90 between the ends 74 and 78 for facilitating rotation of the female coupler 40 relative to the male coupler 42 against the force of the resilient member 72 as the female and male couplers 40 and 42 are coupled. The ramp portions 90 increase in inclination from a base of the respective ramp portion 90 to the respective end 78 to facilitate the compression of the resilient member 72 as the female coupler 40 is being rotated. Each ramp portion 90 includes a rearwardly extending projection 92 at a base of the ramp portion 90 for holding the respective locking element 82, 84 in an intermediate position. When the locking elements 82 and 84 are in the intermediate position, the locking elements 82 and 84 prevent the male coupler 42 from being separated from the female coupler 40 by pressure in the axially extending cavities of the couplers. Fluid in the cavities is also bled through the first and second notches 68 and 70 when the locking elements 82 and 84 are in the intermediate position.

During insertion of the locking elements 82 and 84 into the first and second notches 68 and 70, the locking elements 82 and 84 are advanced through the ends 74 to the ramp portions 90. The locking elements 82 and 84 climb the respective ramp portion 90 until the locking elements reach the end of the respective ramp portion 90 that terminates at a respective lip 94 of the rearwardly facing groove 80. The resilient member 72 compresses progressively as the locking elements 82 and 84 climb the respective ramp portions 90.

The locking elements 82 and 84 are then advanced into a backwall 96 of the respective ends 78. The female or male coupler 40, 42 may then be released and the resilient member 72 urges the locking elements 82 and 84 into the respective rearwardly facing groove 80. To release the locking elements 82 and 84 from the rearwardly facing groove 80, the locking elements 82 and 84 may be shifted rearwardly against the biasing force of the resilient member 72. The dimension between each lip 94 and backwall 96 has a spacing greater than an axial thickness of the respective locking element 82 and 84 to allow for movement of the locking elements 82 and 84 to and from the end 78.

Referring now to the body 60 in detail, the body 60 may be a multi-piece body or a one-piece body having a step on an inner diameter thereof for seating the resilient member 72. As shown, the body 60 is a multi-piece body including a collar portion 100 and a socket portion 102 rotatable relative to the collar portion 100. The collar portion 100 includes the first and second notches 68 and 70, a groove 104 in the cavity 66 for receiving a retainer 106, such as a c-shaped retainer ring, and a radially inwardly protruding portion 108 defining an opening 110 through which the socket portion 102 extends.

The socket portion 102 includes a socket 112 received in the cavity of the collar portion 100 and a rearwardly extending portion 114 having the threads 44 and a groove 116 in an outer wall thereof. The groove 116 receives a retainer 118, such as a c-shaped retainer ring. The radially inwardly protruding portion 108 is captured between a shoulder 120 of the socket 112 and the retainer 118 to prevent separation of the socket portion 102 and the collar portion 100. In this way the socket portion 102 is able to rotate relative to the collar portion 100, for example due to movement of the hose coupled to the threads 44.

The resilient member 72, which may be a plurality of axially aligned resilient members, has one end seated against a shoulder 130 of the socket 112 at a forward end 132 of the socket 112 and another end seated against the retainer 106 when the female and male couplers 40 and 42 are uncoupled. The resilient member 72 has an axial length in an uncompressed state that is greater than a spacing between the shoulder 130 and a shoulder 134 of the male coupler 42 when the female and male couplers 40 and 42 are coupled together. As the female and male couplers 40 and 42 are coupled together, the shoulder 134 compresses the resilient member 72 and moves the resilient member 72 off of the retainer 106. The shoulder 134 then serves as the seat for the end of the resilient member 72 as the resilient member 72 keeps the female and male coupler 40 and 42 in tension and prevents separation under pressure and/or due to vibration.

With continued reference to FIGS. 2-4, the male coupler 42 includes a body 150, one or more locking elements, and in the illustrated embodiment the first and second locking elements 82 and 84, and a suitable seal 152, such as an o-ring disposed in an o-ring groove 154 in an outer surface of the body 150. The body 150 has a forward end 156 configured to be received in the axially extending cavity 66 of the female coupler 40, a rearward end 158 having the threads 46, an axially extending cavity 160 in fluidic communication with the axially extending cavity 66 of the female coupler 40 when the female and male couplers 40 and 42 are connected, and two or more flats 162 and 164 serving as a wrenching surface.

The first and second locking elements 82 and 84 may be protrusions projecting outward from the body 150, such as rounded headed bolts threaded into the body 150 and having a wrenching socket. Alternatively, it will be appreciated that the locking elements 82 and 84 may be formed integrally with the body 150. The locking elements 82 and 84 may project radially outwardly from the body and be circumferentially spaced, for example equally circumferentially spaced.

The first and second locking elements 82 and 84 are movable between a release position when the female and male couplers 40 and 42 are uncoupled, an intermediate position on the ramp surface 90, and a locked position in the rearwardly facing groove 80 preventing separation of the female and male couplers 40 and 42 and constraining the male coupler 42 against rotation with respect to the female coupler 40. By constraining the male coupler 42 against rotation with respect to the female coupler 40, the locking elements 82 and 84 prevent or substantially prevents wear on the seal 152, for example during turns of the vehicle.

Referring now to a method of connecting the female and male couplers 40 and 42, when the female and male couplers 40 and 42 are disconnected as shown in FIGS. 3 and 4, the resilient member 72 is seated against the shoulder 130 of the socket 112 and the retainer 106 in the cavity 66. As the male coupler 42 is inserted into the axially extending cavity 66, the first and second locking elements 82 and 84 are received at the respective insertion ends 74 of the first and second notches 68 and 70 and advanced through the ends 74 to the ramp portions 90. The first and second locking elements 82 and 84 climb the respective ramp portions 90 until the first and second locking elements 82 and 84 reach the end of the respective ramp portions 90 that terminates at the respective lips 94.

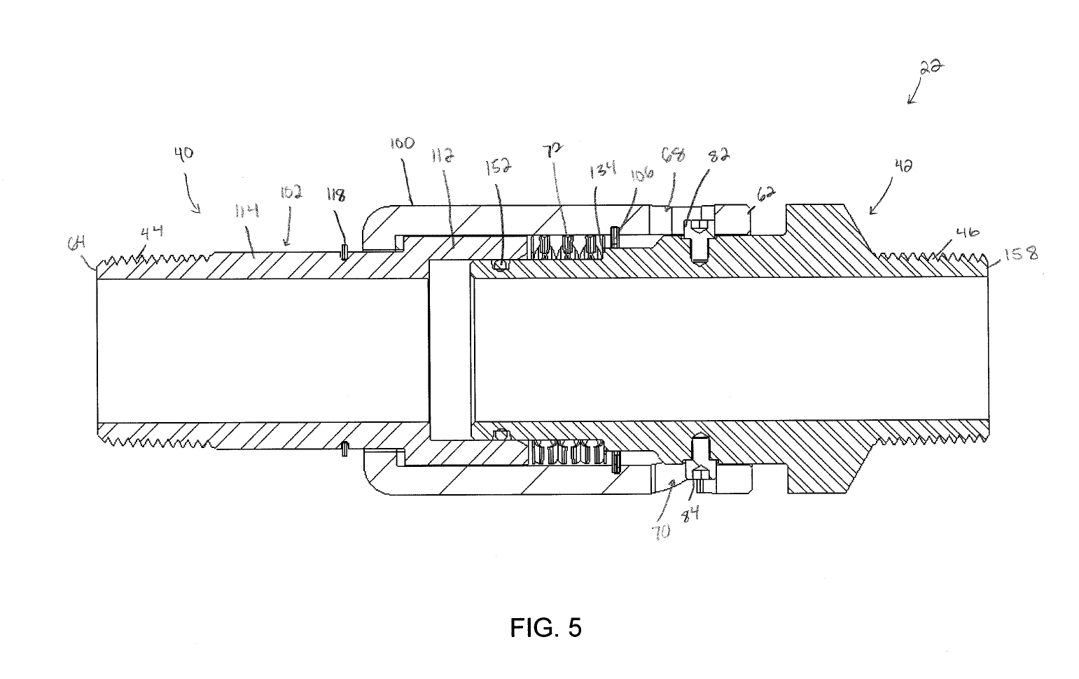

As the first and second locking elements 82 and 84 climb the ramp portions 90, the resilient member 72 is unseated from the retainer 106 and seated on the shoulder 134 of the male coupler 42. Advancement of the male coupler 42 moves the shoulder 134 rearwardly, thereby progressively compressing the resilient member 72. The first and second locking elements 82 and 84 are then advanced into the backwalls 96 of the respective ends 78 of the first and second notches 68 and 70. The operator can then release one of the female or male couplers 40 and 42, or guide the female or male couplers 40 and 42 as the resilient member 72 urges the first and second locking elements 82 and 84 forward, away from the backwalls 96 and into the respective rearwardly facing grooves 80. The locking elements 82 and 84 are held in the rearwardly facing grooves 80 in the locked position as shown in FIGS. 2 and 5 by the biasing force of the resilient member 72.

When the first and second locking elements 82 and 84 are held in the rearwardly facing grooves 80, the seal 152 seals against an inner surface of the socket 112 of the female body 60 as shown in FIG. 5 to prevent leakage between the couplers 40 and 42. Fluid can then flow from the hose connected to one of the female or male couplers 40 and 42 via the threads 44 and 46, through the axially extending cavities 66 and 160, and to the hose connected to the other of the female or male couplers 40 and 42.

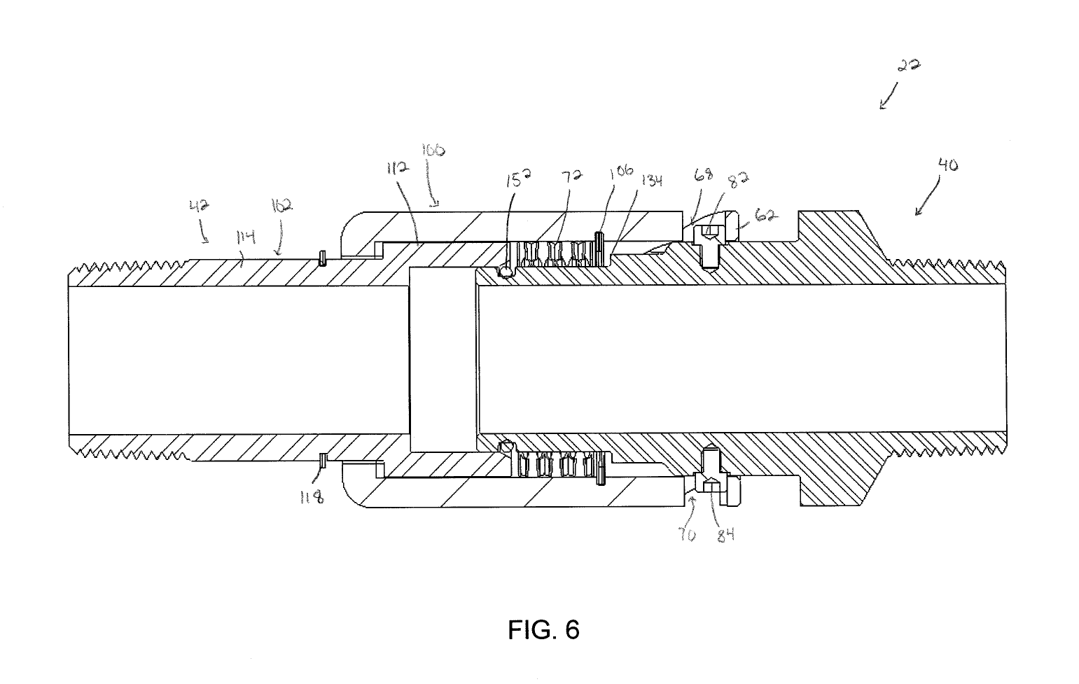

To disconnect the male and female couplers 40 and 42, the male coupler 42 is moved relative to the female coupler 40 rearwardly to move the locking elements 82 and 84 towards the backwalls 96 against the force of the resilient member 72. The male coupler 42 may then be rotated to the intermediate position shown in FIG. 6 where the first and second locking elements 82 and 84 are held by the respective rearwardly extending projections 92. When in the intermediate position, the first and second locking elements 82 and 84 prevent separation of the male coupler 42 from the female coupler 40 due to pressure in the axially extending cavities 66 and 160, while allowing any remaining pressure in the cavities 66 and 160 to be bled through the first and second notches 68 and 70. The first and second locking elements 82 and 84 are then rotated past the respective rearwardly extending projections 92 and then through the ends 74 of the first and second notches 68 and 70 to disconnect the female and male couplers 40 and 42.

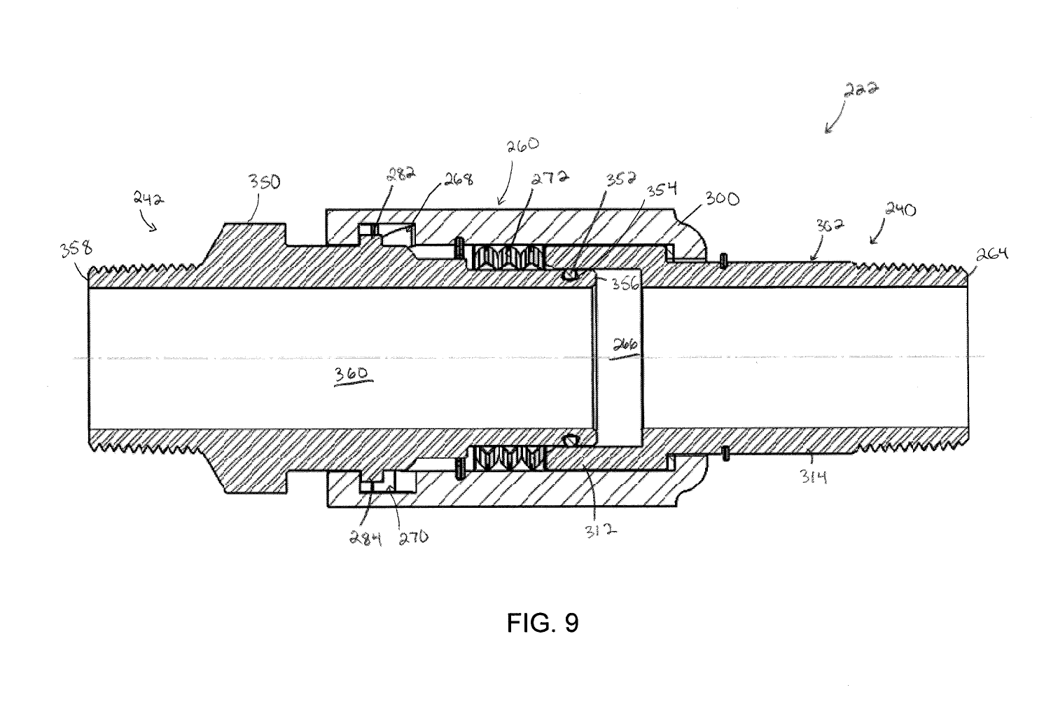

Turning now to FIGS. 7-11, an exemplary embodiment of the coupling is shown at 222. The coupling 222 is substantially the same as the above-referenced coupling 22, and consequently the same reference numerals but indexed by 200 are used to denote structures corresponding to similar structures in the couplings. In addition, the foregoing description of the coupling 22 is equally applicable to the coupling 222 except as noted below. Moreover, it will be appreciated upon reading and understanding the specification that aspects of the couplings may be substituted for one another or used in conjunction with one another where applicable.

Referring to FIGS. 7-9, the coupling 222 includes a female coupler 240 and a male coupler 242 that may be connected to provide liquid from one of the tanks 16 to the hose 20, for example. The female coupler 240 includes a body 260 having a forward end 262, a rearward end 264, an axially extending cavity 266 for receiving the male coupler 242 at the forward end 262, and one or more notches, such as first and second notches 268 and 270, and a resilient member 272 disposed in the axially extending cavity 266. The first and second notches 268 and 270 are internal to the body 260, and therefore do not extend through the body 260. By providing the notches internal to the body 260, the wall of the body provides strength to the rearwardly extending projections 292 (FIG. 11) of the notches 268 and 270. The first and second notches 268 and 270 have a substantially similar internal profile to the first and second notches 68 and 70.

The body 260 is shown as a multi-piece body including a collar portion 300 and a socket portion 302 rotatable relative to the collar portion 300. The collar portion 300 includes the first and second notches 268 and 270, and the socket portion 302 includes a socket 312 received in the cavity of the collar portion 300 and a rearwardly extending portion 314.

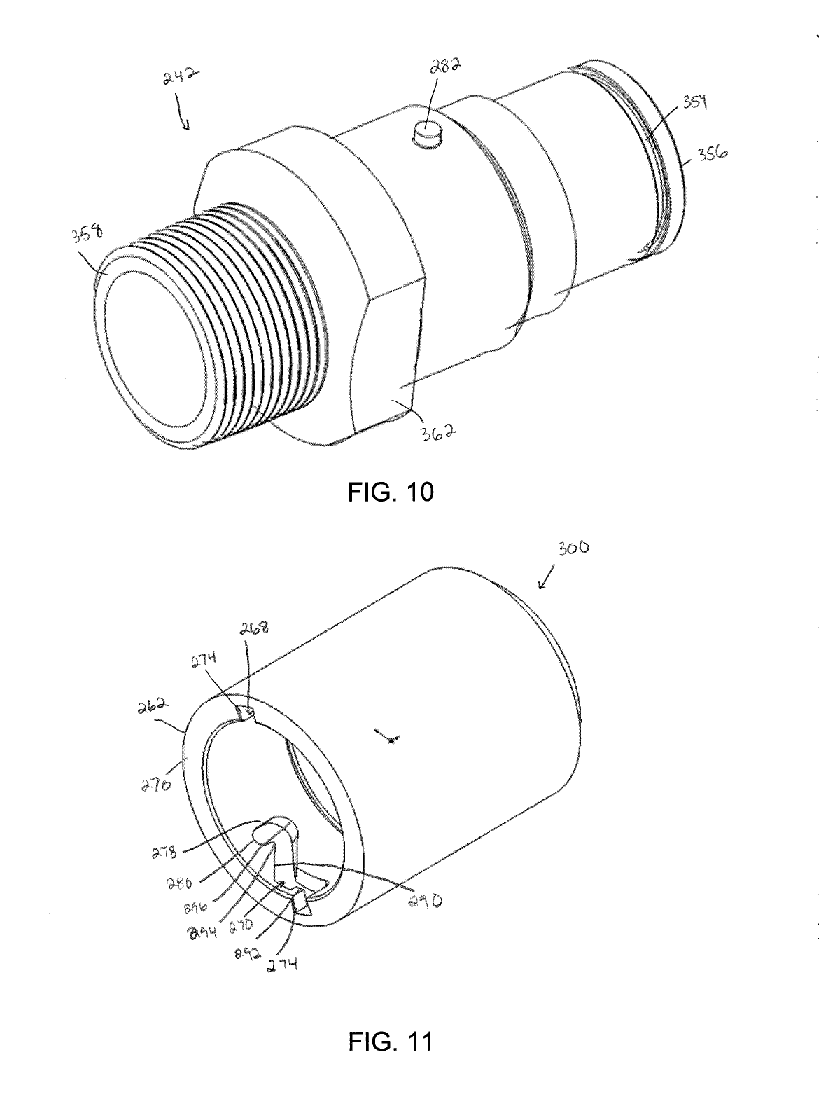

Referring to FIG. 10 in addition to FIGS. 7-9, the male coupler 242 includes a body 350, one or more locking elements, and in the illustrated embodiment first and second locking elements 282 and 284 integral with the body 350 and projecting outwardly from the body 350, and a suitable seal 352, such as an o-ring disposed in an o-ring groove 354 in an outer surface of the body 350. The body 350 has a forward end 356 configured to be received in the axially extending cavity 266 of the female coupler 240, a rearward end 358, an axially extending cavity 360 in fluidic communication with the axially extending cavity 266 of the female coupler 240, and two or more flats 362 and 364 serving as a wrenching surface. When the first and second locking elements 282 and 284 are in the intermediate position, the first and second locking elements 282 and 284 prevent separation of the male coupler 242 from the female coupler 240 due to pressure in the axially extending cavities 266 and 360, while allowing any remaining pressure in the cavities 266 and 360 to be bled through a gap between the female and male couplers 240 and 242.

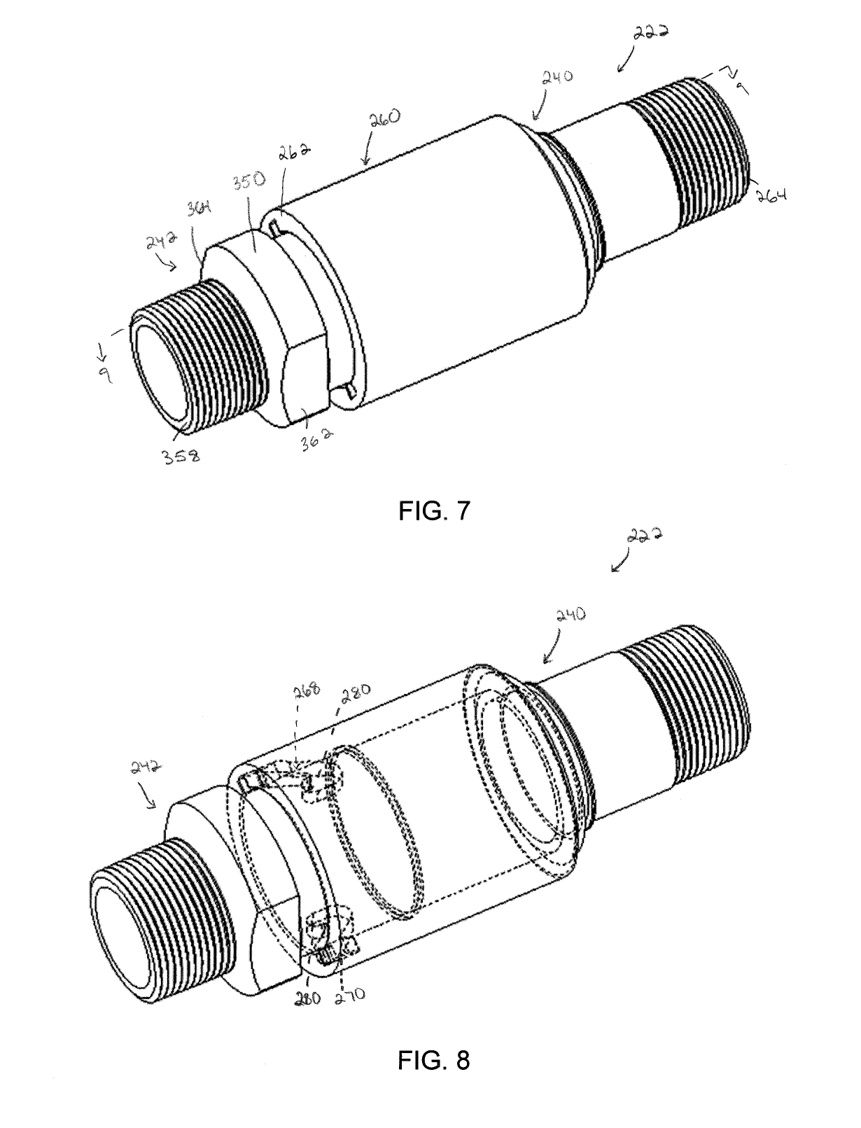

Referring now to FIG. 11, the collar portion 300 is shown. As noted above, the collar portion 300 includes the first and second notches 268 and 270. The first and second notches 268 and 270 may be oppositely oriented and each have diametrically opposed ends 274 opening to an axial end face 276 of the body 260 at the forward end 262, and opposite ends 278 having a rearwardly facing groove 280. The rearwardly facing grooves 280 retain a respective locking element 282, 284 of the male coupler 242 as shown in FIG. 8. The first and second notches 268 and 270 each also include a ramp portion 290 between the ends 274 and 278 for facilitating rotation of the female coupler 240 relative to the male coupler 242 against the force of the resilient member 272. Each ramp portion 290 includes a rearwardly extending projection 292 at a base of the ramp portion 290 for holding the respective locking element 282, 284 in an intermediate position.

During insertion of the first and second locking elements 282 and 284 into the first and second notches 268 and 270, the locking elements 282 and 284 climb the respective ramp portion 290 until the locking elements 282 and 284 reach the end of the respective ramp portion 290 that terminates at a respective lip 294 of the rearwardly facing groove 280. The first and second locking elements 282 and 284 are then advanced into a backwall 296 of the respective ends 278, and when the female or male coupler 240, 242 is released, the resilient member 272 urges the locking elements 282 and 284 into the respective rearwardly facing groove 280.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A coupling including female and male couplers configured to be coupled together,
the male coupler including a body having a forward end, a rearward end, an axially extending cavity, and a locking element; and
the female coupler including a body having a forward end, a rearward end, an axially extending cavity for receiving the forward end of the male coupler at the forward end, and a notch having one end opening to an axial end face of the body at the forward end and an opposite end having a rearwardly facing groove for retaining the locking element to prevent rotation of the male coupler relative to the body of the female coupler and to prevent separation of the male and female couplers.

2. The coupling according to claim 1, wherein the female coupler includes a resilient member disposed in the axially extending cavity, and wherein the resilient member is interposed between respective stop shoulders on the male and female couplers for resiliently holding the locking element in the rearwardly facing groove.

3. The coupling according to claim 2, wherein the locking element is shiftable rearwardly against the biasing force of the resilient member to release the locking element from the rearwardly facing groove.

4. The coupling according to claim 2, wherein the resilient member has an axial length in an uncompressed state that is greater than a spacing between the stop shoulders when the male and female couplers are coupled together.

5. The coupling according to claim 2, wherein the notch includes a ramp portion between the ends for facilitating rotation of the female coupler relative to the male coupler against the force of the resilient member.

6. The coupling according to claim 5, wherein the resilient member is configured to compress progressively as the locking element climbs the ramp portion.

7. The coupling according to claim 5, wherein the ramp portion includes a rearwardly extending projection at a base of the ramp portion for holding the locking element in an intermediate position to prevent separation of the male coupler from the female coupler due to pressure in the axially extending cavities.

8. The coupling according to claim 7, whereby fluid in the axially extending cavities is bled through the notch when the locking element is in the intermediate position.

9. The coupling according to claim 2, wherein when the female and male couplers are uncoupled, one end of the resilient member is seated on the stop shoulder of the female coupler and another end of the resilient member is seated against a retainer disposed in the axially extending cavity.

10. The coupling according to claim 1, wherein the male coupler includes a pair of locking elements and the female coupler includes a pair of notches each having one end opening to the axial end face of the body at the forward end and an opposite end having a rearwardly facing groove for retaining a respective one of the locking elements.

11-14. (canceled)

15. The coupling according to claim 10, wherein the locking elements are equally circumferentially spaced.

16-19. (canceled)

20. A female coupler including:
a body having a forward end, a rearward end, an axially extending cavity for receiving a male coupler at the forward end, and a notch having one end opening to an axial end face of the body at the forward end and an opposite end having a rearwardly facing groove for retaining a locking element of the male coupler to prevent separation of the male and female couplers; and
a resilient member disposed in the axially extending cavity and being interposed between a stop shoulder of the body and a retainer disposed in the axially extending cavity.

21. The female coupler according to claim 20, wherein the notch includes a ramp portion between the ends for facilitating rotation of the female coupler relative to the male coupler against the force of the resilient member.

22. The female coupler according to claim 21, wherein the resilient member is configured to compress progressively as the locking element climbs the ramp portion.

23. The female coupler according to claim 21, wherein the ramp portion includes a rearwardly extending projection at a base of the ramp portion for holding the locking element in an intermediate position to prevent separation of the male coupler from the female coupler due to pressure in the axially extending cavity.

24. The female coupler according to claim 23, whereby fluid in the axially extending cavity is bled through the notch when the locking element is in the intermediate position.

25. The female coupler according to claim 20, wherein the female coupler includes a pair of notches each having one end opening to the axial end face of the body at the forward end and an opposite end having a rearwardly facing groove for retaining a respective locking element.

26-27. (canceled)

28. The female coupler according to claim 20, wherein the body includes a collar portion and a socket portion rotatable relative to the collar portion.

29. The female coupler according to claim 28, wherein the collar portion includes a radially inwardly protruding portion defining an opening through which the socket portion extends.

30. (canceled)

31. A female coupler having a forward end, a rearward end, an axially extending cavity for receiving a male coupler at the forward end, and a notch having an entry portion into which a locking element of the male coupler is configured to be received, an intermediate ramp portion through which the anti-rotate element is configured to climb, and a lock portion having a rearwardly facing locking groove for retaining the locking element to prevent separation of the male and female couplers and to constrain the male coupler against rotation.
